(19) United States
(12) Patent Application Publication
(10) Pub. No.: US 2011/0205519 A1
(43) Pub. Date: Aug. 25, 2011

(54) POLARIZATION CONVERTING UNIT, ILLUMINATION OPTICAL SYSTEM, EXPOSURE APPARATUS, AND DEVICE MANUFACTURING METHOD

(75) Inventors: Nobumichi KANAYAMAYA, Kumagaya-shi (JP); Osamu TANITSU, Kumagaya (JP)

(73) Assignee: NIKON CORPORATION, Tokyo (JP)

(21) Appl. No.: 12/835,860

(22) Filed: Jul. 14, 2010

Related U.S. Application Data
(60) Provisional application No. 61/308,126, filed on Feb. 25, 2010.

(51) Int. Cl. G03B 27/72; G02F 1/29

(52) U.S. Cl. 355/71; 359/301; 355/77

(57) ABSTRACT

According to one embodiment, a polarization converting unit, for converting incident light into light in a predetermined polarization state and emitting the converted light, has a first optically rotatory member having a first thickness distribution of thicknesses in an optical-axis direction different at a plurality of locations and a second optically rotatory member having a second thickness distribution, each of which is a member to rotate linearly polarized light incident thereto as propagating light, around the optical-axis direction. The first and second optically rotatory members are comprised of an optical material with an optical activity arranged so as to have a crystal axis coincident or parallel with the optical-axis direction. Particularly, the sum of respective thicknesses of superimposed regions in the first and second optically rotatory members is different from the sum of respective thicknesses of other superimposed regions in the first and second optically rotatory members when viewed along the optical-axis direction.

### CROSS-REFERENCE TO RELATED APPLICATIONS

This application is based upon and claims the benefit of priority from Provisional Application No. 61/208,126, filed on Feb. 25, 2010, the entire contents of which are incorporated herein by reference.

### BACKGROUND

1. Field

One embodiment of the invention relates to a polarization converting unit, an illumination optical system, an exposure apparatus, and a device manufacturing method. More particularly, the present invention relates to an illumination optical system suitably applicable to an exposure apparatus for manufacturing such devices as semiconductor devices, imaging devices, liquid crystal display devices, and thin film magnetic heads by lithography.

2. Description of the Related Art

In a typical exposure apparatus of this type, a light beam emitted from a light source travels through a fly's eye lens as an optical integrator to form a secondary light source as a substantial surface illuminant consisting of a large number of light sources. The secondary light source generally means a predetermined light intensity distribution on an illumination pupil. The light intensity distribution on the illumination pupil will be referred to hereinafter as a “pupil intensity distribution.” The illumination pupil is defined as a position such that an illumination target surface becomes a Fourier transform plane of the illumination pupil by action of an optical system between the illumination pupil and the illumination target surface. In the case of the exposure apparatus, the illumination target surface corresponds to a mask or a wafer.

Beams from the secondary light source are condensed by a condenser optical system and then superposedly illuminate the mask on which a predetermined pattern is formed. Light passing through the mask travels through a projection optical system to be focused on the wafer, whereby the mask pattern is projected (or transferred) onto the wafer to effect exposure thereof. The pattern formed on the mask is a highly integrated one. For this reason, an even illuminance distribution must be obtained on the wafer in order to accurately transfer this microscopic pattern onto the wafer.

There is a recently proposed illumination optical system achieving an illumination condition suitable for faithfully transferring the microscopic pattern in any direction. This illumination optical system is so set that the secondary light source of an annular shape is formed on the illumination pupil at or near the rear focal plane of the fly's eye lens and that the polarization state of the light passing through the annular secondary light source is converted into a state of polarization rotating in the circumferential direction of the secondary light source (which will be referred to hereinafter as a “circumferentially polarized state”). The illumination optical system described in U.S. Patent Application Laid-Open No. 2006/0170901 uses a polarization converting element with an optical activity having four to eight divided regions of a fan shape to set polarization states of beams passing through the respective regions, in the circumferential direction, thereby achieving the circumferentially polarized state with relatively low so-called continuity.

### SUMMARY

According to an embodiment of the invention, a polarization converting unit, arranged on an optical axis of an optical system and configured to convert a polarization state of propagating light passing along an optical-axis direction corresponding to the optical axis, comprises a first optically rotatory member and a second optically rotatory member. The first optically rotatory member is comprised of an optical material with an optical activity, which is arranged so as to have a crystal axis coincident or parallel with the optical-axis direction and so as to rotate linearly polarized light incident thereto as the propagating light, around the optical-axis direction. The first optically rotatory member has a first thickness distribution of thicknesses in the optical-axis direction different at a plurality of locations. On the other hand, the second optically rotatory member is also comprised of an optical material with an optical activity, which is arranged so as to have a crystal axis coincident or parallel with the optical-axis direction and so as to further rotate linearly polarized light incident thereto as the propagating light through the first optically rotatory member, around the optical-axis direction. This second optically rotatory member has a second thickness distribution of thicknesses in the optical-axis direction different at a plurality of locations.

The first and second optically rotatory members may be arranged so that the sum of respective thicknesses in the optical-axis direction at predetermined locations in the first and second optically rotatory members through which a first reference axis parallel to the optical-axis direction passes is different from the sum of respective thicknesses in the optical-axis direction at other locations in the first and second optically rotatory members through which a second reference axis parallel to the optical-axis direction and different from the first reference axis passes.

For purposes of summarizing the invention, certain aspects, advantages, and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a drawing schematically showing a configuration of an exposure apparatus according to an embodiment;

FIG. 2 is a drawing showing an annular pupil intensity distribution formed on an illumination pupil immediately after a micro fly's eye lens;

FIG. 3 is a drawing schematically showing a configuration of a polarization converting unit;

FIGS. 4A to 4C are drawings schematically showing a configuration of each optically rotatory member in the polarization converting unit;

FIG. 5 is a drawing schematically showing another configuration of each optically rotatory member in the polarization converting unit;

FIG. 6 is a drawing for explaining a positional relation between regions in respective optically rotatory members in the polarization converting unit;

FIG. 7 is a drawing for explaining the optical activity of quartz crystal;

FIG. 8 is a drawing showing an annular light intensity distribution in a substantially continuous, circumferentially polarized state formed by action of the polarization converting unit;

FIG. 9 is a drawing showing an annular light intensity distribution in a substantially continuous, radially polarized state formed by action of the polarization converting unit;

FIG. 10 is a drawing schematically showing a configuration of a polarization converting unit according to a modification example;

FIG. 11 is a drawing schematically showing a configuration of each optically rotatory member in the polarization converting unit according to the modification example;

FIG. 12 is a drawing showing an annular light intensity distribution in a substantially continuous, circumferentially polarized state formed by action of the polarization converting unit according to the modification example;

FIG. 13 is a drawing showing an example in which one optically rotatory member is composed of a pair of divided members each integrally formed;

FIG. 14 is a flowchart showing manufacturing steps of semiconductor devices; and

FIG. 15 is a flowchart showing manufacturing steps of a liquid crystal device such as a liquid crystal display device.

### DETAILED DESCRIPTION

Various embodiments according to the Invention will be described hereinafter with reference to the accompanying drawings.

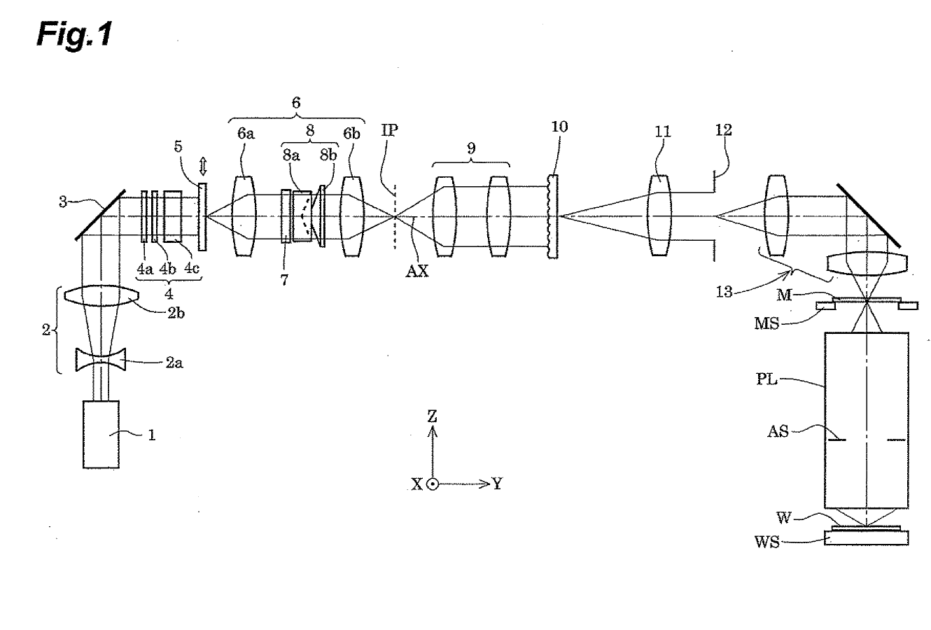

FIG. 1 is a drawing schematically showing a configuration of an exposure apparatus according to an embodiment. In FIG. 1, the Z-axis is set along a direction of a normal to a transfer surface (exposed surface) of a wafer W being a photosensitive substrate, the Y-axis along a direction parallel to the plane of FIG. 1 in the transfer surface of the wafer W, and the X-axis along a direction normal to the plane of FIG. 1 in the transfer surface of the wafer W. With reference to FIG. 1, a light source 1 supplies exposure light (illumination light) in the exposure apparatus of the present embodiment.

The light source 1 applicable herein is, for example, a KrF excimer laser light source to supply light at the wavelength of 248 nm, or an ArF excimer laser light source to supply light at the wavelength of 193 nm. The nearly parallel light emitted along the Z-direction from the light source 1 has a rectangular cross section elongated, for example, along the X-direction and is incident into a beam expander 2 consisting of a pair of lenses 2a and 2b. The light incident into the beam expander 2 is expanded in the plane of FIG. 1 to be shaped into a beam having a predetermined rectangular cross section.

The nearly parallel light having passed through the beam expander 2 as a shaping optical system is deflected into the Y-direction by a mirror 3 and then travels through a polarization state switch unit 4 and a diffractive optical element 5 for annular illumination, to enter an afocal lens 6. The polarization state switch unit 4 is composed of a quarter wave plate 4a the crystal optic axis of which is arranged to be rotatable about the optical axis AX and which converts elliptically polarized light incident thereto, into linearly polarized light, a half wave plate 4b the crystal optic axis of which is arranged to be rotatable about the optical axis AX and which changes a direction of polarization of incident linearly polarized light, and a depolarizer (depolarizing element) 4e which is arranged so as to be freely loaded in or unloaded from the illumination optical path.

In a state in which the depolarizer 4c is unloaded from the illumination optical path, the polarization state switch unit 4 has a function to convert the light from the light source 1 into linearly polarized light having a desired polarization direction and guide the linearly polarized light into the diffractive optical element 5. Furthermore, in a state in which the depolarizer 4c is loaded in the illumination optical path, the polarization state switch unit 4 has a function to convert the light from the light source 1 into substantially unpolarized light and guide the unpolarized light into the diffractive optical element 5. The afocal lens 6 is composed of a front lens unit 6a and a rear lens unit 6b. The afocal lens 6 is an afocal system (afocal optical system) that is so set that the front focus position of the front lens unit 6a agrees substantially with the position of the diffractive optical element 5 and that the rear focus position of the rear lens unit 6b agrees substantially with a position of a predetermined plane IP indicated by a dashed line in the drawing.

In general, a diffractive optical element is made by forming level differences at the pitch approximately equal to the wavelength of the exposure light (illumination light) in a substrate, and has the action to diffract an incident beam to desired angles. Specifically, the diffractive optical element 5 for annular illumination has the following function: when a parallel beam with a rectangular cross section is incident thereto, it forms an annular light intensity distribution in its far field (or Fraunhofer diffraction region). Therefore, the nearly parallel beam incident to the diffractive optical element 5 forms an annular light intensity distribution at the pupil position of the afocal lens 6 and is then emitted as a nearly parallel beam from the afocal lens 6.

A polarization converting unit 7 and a conical axicon system 8 are arranged at or near the pupil position of the afocal lens 6. The configurations and actions of the polarization converting unit 7 and the conical axicon system 8 will be described later. The below will describe the basic configuration and action of the exposure apparatus, while ignoring the actions of the polarization converting unit 7 and the conical axicon system 8. The beam having passed through the afocal lens 6 travels through a zoom lens 9 for varying the σ value (σ value=mask-side numerical aperture of the illumination optical apparatus/mask-side numerical aperture of the projection optical system), to enter a micro fly's eye lens (or fly's eye lens) 10 as an optical integrator.

The micro fly's eye lens 10 is, for example, an optical element consisting of a large number of microscopic lenses with a positive refractive power arrayed vertically and horizontally and densely. In general, a micro fly's eye lens is constructed, for example, by forming the microscopic lens group by etching of a plane-parallel plate. Each of the microscopic lenses constituting the micro fly's eye lens is smaller than each of lens elements constituting a fly's eye lens. In the micro fly's eye lens, different from the fly's eye lens consisting of mutually isolated lens elements, the large number of microscopic lenses (microscopic refracting faces) are integrally formed without being isolated from each other.

However, the micro fly's eye lens is an optical integrator of the same wavefront division type as the fly's eye lens in terms of the configuration wherein the lens elements with the positive refractive power are arranged vertically and horizontally. It is also possible to use, for example, a cylindrical micro fly's eye lens as the micro fly's lens 10. The configuration and action of the cylindrical micro fly's eye lens are disclosed, for example, in U.S. Pat. No. 6,913,373. The disclosure of U.S. Pat. No. 6,913,373 above is incorporated herein by reference.

The position of the predetermined plane IP is located at or near the front focus position of the zoom lens 9 and the entrance plane of the micro fly's eye lens 10 is located at or near the rear focus position of the zoom lens 9. In other words, the zoom lens 9 acts to arrange the predetermined plane IP and the entrance plane of the micro fly's eye lens 10 substantially in the relation of Fourier transform and, in turn, to arrange the pupil plane of the afocal lens 6 and the entrance plane of the micro fly's eye lens 10 optically substantially conjugate with each other. Therefore, for example, an annular illumination field centered on the optical axis AX on a plane perpendicular to the optical axis AX is formed on the entrance plane of the micro fly's eye lens 10 as on the pupil plane of the afocal lens 6. (In the description hereinafter, expressions of the shape and others based on the optical axis AX are defined on the plane perpendicular to the optical axis.) The overall shape of this annular illumination field similarly varies depending upon the focal length of the zoom lens 9.

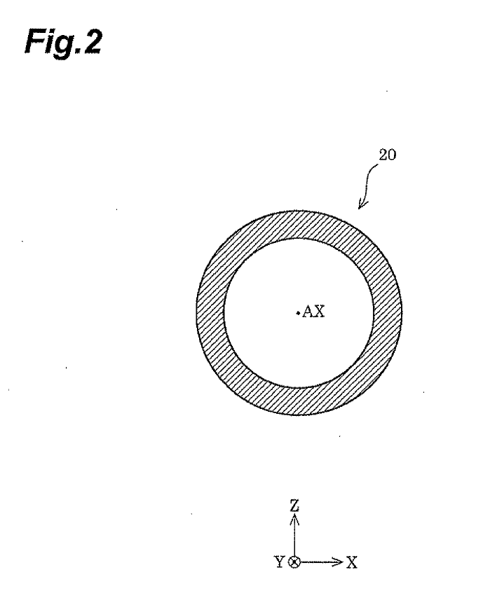

Each microscopic lens forming the micro fly's eye lens 10 has a cross section of a rectangular shape similar to a shape of an illumination field to be formed on the mask M (and, in turn, similar to a shape of an exposure region to be formed on the wafer W). The light entering the micro fly's eye lens 10 is two-dimensionally divided by the large number of microscopic lenses to form a secondary light source with a light intensity distribution substantially identical with the illumination field formed on the entrance plane, i.e., a secondary light source (annular pupil intensity distribution) 20 consisting of an annular substantial surface illuminant centered on the optical axis AX, as shown in FIG. 2, at the illumination pupil lying at or near the rear focal plane of the micro fly's eye lens 10.

Beams of light from the secondary light source 20 formed on the illumination pupil immediately after the micro fly's eye lens 10 travel through a condenser optical system 11 to illuminate a mask blind 12 in a superimposed manner. In this manner, a rectangular illumination field according to the shape and focal length of each microscopic lens forming the micro fly's eye lens 10 is formed on the mask blind 12 as an illumination field stop. Beams of light passing through a rectangular aperture (light transmitting part) of the mask blind 12 are subjected to condensing action of an imaging optical system 13 and thereafter superposedly illuminate the mask M on which a predetermined pattern is formed.

Namely, the imaging optical system 13 forms an image of the rectangular aperture of the mask blind 12 on the mask M. The pupil of the imaging optical system 13 is another illumination pupil located at a position optically conjugate with the illumination pupil at or near the rear focal plane of the micro fly's eye lens 10. Accordingly, an annular pupil intensity distribution is also formed at the pupil position of the imaging optical system 13 as at the illumination pupil immediately after the micro fly's eye lens 10.

Light transmitted by the mask M held on a mask stage MS travels through the projection optical system PL to form an image of the mask pattern on the wafer (photosensitive substrate) W held on a wafer stage WS. In this manner, the pattern of the mask M is sequentially transferred to each of exposure regions on the wafer W by carrying out full-shot exposure or scan exposure while two-dimensionally driving and controlling the wafer stage WS in a plane (XY plane) perpendicular to the optical axis AX of the projection optical system PL and, therefore, while two-dimensionally driving and controlling the wafer W.

The conical axicon system 8 is composed of a first prism member 8a and a second prism member 8b arranged in order from the light source side. The first prism member 8a has a plane on the light source side and a refracting surface of a concave conical shape on the mask side. The second prism member 8b has a plane on the mask side and a refracting surface of a convex conical shape on the light source side. The concave conical refracting surface of the first prism member 8a and the convex conical refracting surface of the second prism member 8b are complementarily formed so as to be able to butt each other. Namely, at least one of the first prism member 8a and the second prism member 8b is arranged as movable along the optical axis AX so as to vary the spacing between the concave conical refracting surface of the first prism member 8a and the convex conical refracting surface of the second prism member 8b.

In a state in which the concave conical refracting surface of the first prism member 8a and the convex conical refracting surface of the second prism member 8b butt each other, the conical axicon system 8 functions as a plane-parallel plate and causes no effect on the annular secondary light source formed. However, as the concave conical refracting surface of the first prism member 8a and the convex conical refracting surface of the second prism member 8b are moved away from each other, the outside diameter (inside diameter) of the annular secondary light source varies while the width of the annular secondary light source (half of the difference between the outside diameter and the inside diameter of the annular secondary light source) is kept constant. Namely, the separation of the two members results in change in the annular ratio (inside diameter/outside diameter) and the size (outside diameter) of the annular secondary light source.

The zoom lens 9 has a function to similarly (isotropically) enlarge or reduce the overall shape of the annular secondary light source. For example, when the focal length of the zoom lens 9 is increased from a minimum to a predetermined value, the overall shape of the annular secondary light source is similarly enlarged. In other words, the action of the zoom lens 9 is to vary both the width and the size (outside diameter) of the annular secondary light source, without change in the annular ratio thereof. In this manner, the annular ratio and size (outside diameter) of the annular secondary light source can be controlled by the actions of the conical axicon system 8 and the zoom lens 9.

In the present embodiment, the mask M arranged on an illumination target surface of the illumination optical system (2-13) is illuminated by Köhler illumination using the secondary light source formed immediately after the micro fly's eye lens 10, as a light source. For this reason, the position where the secondary light source is formed is optically conjugate with the position of an aperture stop AS of the projection optical system PL and the plane where the secondary light source is formed can be called an illumination pupil plane of the illumination optical system (2-13). Typically, the illumination target surface (the plane where the mask M is arranged or the plane where the wafer W is arranged in the case where the illumination optical system is considered to include the projection optical system PL) is an optical Fourier transform plane with respect to the illumination pupil plane.

The pupil intensity distribution is a light intensity distribution (luminance distribution) on the illumination pupil plane of the illumination optical system (2-13) or on a plane optically conjugate with the illumination pupil plane. When the number of divisions of the wavefront by the micro fly's eye lens 10 is relatively large, the overall light intensity distribution formed on the entrance plane of the micro fly's eye lens 10 demonstrates a high correlation with the overall light intensity distribution (pupil intensity distribution) of the entire secondary light source. For this reason, the light intensity distributions on the entrance plane of the micro fly's eye lens 10 and on a plane optically conjugate with the entrance plane (e.g., the pupil plane of the afocal lens 6) can also be called pupil intensity distributions. Therefore, the entrance plane of the micro fly's eye lens 10 and the plane optically conjugate with the entrance plane are also referred to as illumination pupil planes.

A diffractive optical element for multi-polar illumination (not shown) can be set instead of the diffractive optical element 5 for annular illumination in the illumination optical path, thereby to implement multi-polar illumination (bipolar illumination, quadrupolar illumination, octupolar illumination, or the like). When a parallel beam with a rectangular cross section is incident to the diffractive optical element for multi-polar illumination, the diffractive optical element for multi-polar illumination functions to form a light intensity distribution of a multi-polar shape (bipolar, quadrupolar, octupolar, or other shape) in its far field. Therefore, light having passed through the diffractive optical element for multi-polar illumination forms an illumination field of a multi-polar shape, for example, consisting of a plurality of circular illumination fields around the optical axis AX, on the entrance plane of the micro fly's eye lens 10. As a result, the secondary light source of the same multi-polar shape as the illumination field formed on the entrance plane is also formed on the illumination pupil immediately after the micro fly's eye lens 10.

When a diffractive optical element for circular illumination (not shown) is set instead of the diffractive optical element 5 for annular illumination in the illumination optical path, it can implement normal circular illumination. When a parallel beam with a rectangular cross section is incident to the diffractive optical element for circular illumination, the diffractive optical element for circular illumination functions to form a light intensity distribution of a circular shape in the far field. Therefore, a light beam having passed through the diffractive optical element for circular illumination forms, for example, an illumination field of a circular shape (which is defined on the plane perpendicular to the optical axis) centered on the optical axis AX, on the entrance plane of the micro fly's eye lens 10. As a result, the secondary light source of the same circular shape as the illumination field formed on the entrance plane is also formed on the illumination pupil immediately after the micro fly's eye lens 10. When a diffractive optical element with an appropriate characteristic (not shown) is set instead of the diffractive optical element 5 for annular illumination in the illumination optical path, it becomes feasible to implement one of various forms of modified illuminations.

Instead of or in addition to the aforementioned diffractive optical element, it is also possible to use a spatial light modulator, for example, in a configuration wherein orientations of mirror elements arrayed two-dimensionally are continuously or discretely varied each in multiple levels. The spatial light modulator of this type can be any one of the spatial light modulators, for example, disclosed in European Patent Application Laid-Open No. 779530 (corresponding to Japanese Translation of PCT Application Laid-Open No. 10-503300), U.S. Pat. No. 6,900,915 (corresponding to Japanese Patent Application Laid-Open No. 2004-78136), U.S. Pat. No. 7,095,546 (corresponding to Japanese Translation of PCT Application Laid-Open No. 2006-524349), and Japanese Patent Application Laid-Open No. 2006-113437. For example, U.S. Patent Application Laid-Open No. 2009/0073411, U.S. Patent Application Laid-Open No. 2009/0091730, U.S. Patent Application Laid-Open No. 2009/0109417, U.S. Patent Application Laid-Open No. 2009/0128886, U.S. Patent Application Laid-Open No. 2009/0097094, U.S. Patent Application Laid-Open No. 2009/0097007, U.S. Patent Application Laid-Open No. 2009/0185154, and U.S. Patent Application Laid-Open No. 2009/0116093 disclose the illumination optical systems using such an active spatial light modulator. The disclosures of European Patent Application Laid-Open No. 779530 (corresponding to Japanese Translation of PCT Application Laid-Open No. 10-503300), U.S. Pat. No. 6,900,915 (corresponding to Japanese Patent Application Laid-Open No. 2004-78136), U.S. Pat. No. 7,095,546 (corresponding to Japanese Translation of PCT Application Laid-Open No. 2006-524349), U.S. Patent Application Laid-Open No. 2009/0073411, U.S. Patent Application Laid-Open No. 2009/0091730, U.S. Patent Application Laid-Open No. 2009/0109417, U.S. Patent Application Laid-Open No. 2009/0128886, U.S. Patent Application Laid-Open No. 2009/0097094, U.S. Patent Application Laid-Open No. 2009/0097007, U.S. Patent Application Laid-Open No. 2009/0185154, and U.S. Patent Application Laid-Open No. 2009/0116093 are incorporated herein by reference.

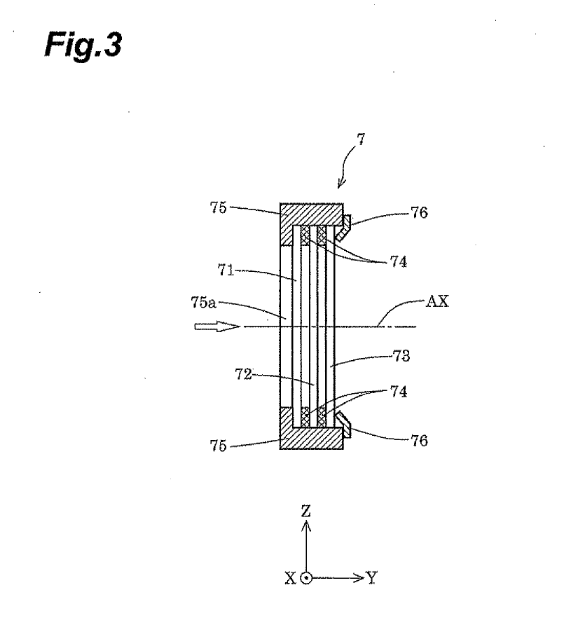

FIG. 3 is a drawing schematically showing the configuration of the polarization converting unit. The polarization converting unit 7, as described above, is arranged at or near the pupil position of the afocal lens 6, i.e., at or near the position of the illumination pupil of the illumination optical system (2-13). In another expression, the polarization converting unit 7 is arranged in a pupil space including the illumination pupil in the optical path of the afocal lens 6. The “pupil space including the illumination pupil” herein is a space along the optical path between the front optical member (front lens unit 6a in the configuration of FIG. 1) arranged on the front side of the illumination pupil and having a power and the rear optical member (conical axicon system 8 in the configuration of FIG. 1) arranged on the rear side of the illumination pupil and having a power.

It is assumed hereinafter for easier understanding of description that the polarization converting unit 7 is arranged so as to be fixed or so as to be freely loaded in or unloaded from the optical path, at the position immediately before the illumination pupil in the optical path of the afocal lens 6. When the diffractive optical element 5 for annular illumination is arranged in the illumination optical path, light having an annular cross section is incident as propagating light into the polarization converting unit 7. The polarization converting unit 7, as shown in FIG. 3, has a first optically rotatory member 71, a second optically rotatory member 72, and a third optically rotatory member 73 in order from the entrance side of light (light source side; left in FIG. 3). The three optically rotatory members 71, 72, 73 each have a form of a plane-parallel plate as a whole and have the same configuration.

The optically rotatory members 71 to 73 are held by a holding frame 75 of a circular ring form so as to be kept in a mutually parallel state through spacers 74. The holding frame 75 is provided with an aperture (light transmitting part) 75a for passage of the beam incident from the light source 1 (not shown in FIG. 3) into the polarization converting unit 7 (the first optically rotatory member 71 eventually). The optically rotatory members 71-73 are held in a stable state at respective required positions inside the holding frame 75, for example, by action of a plurality of stop members 76 provided at intervals in the circumferential direction of the holding frame 75.

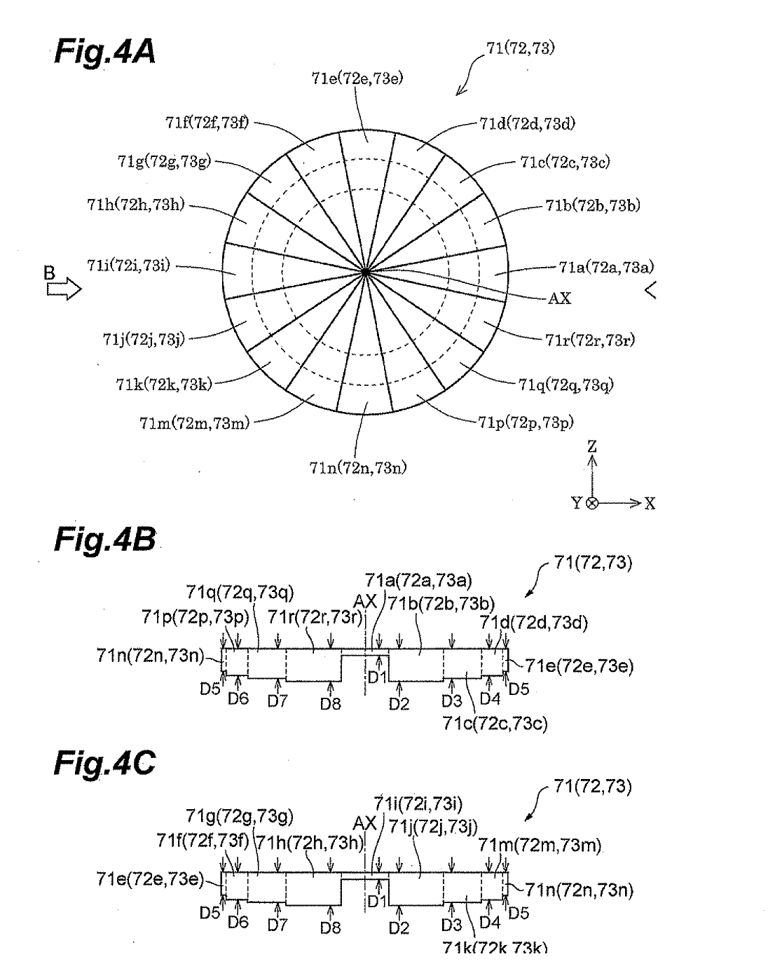

Each optically rotatory member 71-73 is made of a crystal material being an optical material with an optical activity, e.g., quartz crystal. In the state where the optically rotatory members 71-73 are positioned in the optical path, entrance surfaces (and exit surfaces eventually) of the respective optically rotatory members 71-73 are perpendicular to the optical axis AX and their crystal optic axes are approximately coincident with the direction of the optical axis AX (i.e., approximately coincident with the Y-direction which is the traveling direction of incident light). The optically rotatory member 71 (72, 73), as shown in FIG. 4A, has a contour of a circular shape centered on the optical axis AX (or an annular shape not shown) and has sixteen divided regions obtained by dividing the circular shape into sixteen equal regions along the circumferential direction of the circle.

Specifically, the optically rotatory member 71 (72, 73) has, as the sixteen divided regions, regions 71a (72a, 73a), 71b (72b, 73b), 71c (72c, 73e), 71d (72d, 73d), 71e (72e, 73e), 71f (72f, 73f), 71g (72g, 73g), 71h (72h, 73h), 71i (72i, 73i), 71j (72j, 73j), 71k (72k, 73k), 71m (72m, 73m), 71n (72n, 73n), 71p (72p, 73p), 71q (72q, 73q), and 71r (72r, 73r).

The sixteen divided regions 71a (72a, 73a) to 71r (72r, 73r) of the optically rotatory member 71 (72, 73) are such divided regions that sixteen arcuate beams obtained by dividing the incident annular beam (indicated by two dashed-line circles in FIG. 4A) into sixteen equal beams along the circumferential direction pass through the respective regions. Of the sixteen divided regions 71a (72a, 73a) to 71r (72r, 73r), any two divided regions adjacent in the circumferential direction have their respective thicknesses (lengths along the direction of the optical axis AX) different from each other and any two divided regions opposed to each other with the optical axis AX in between have an identical thickness.

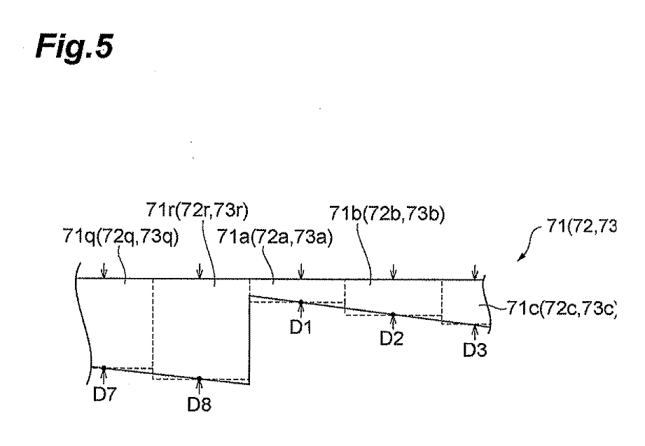

FIG. 4B is a side view of the optically rotatory member 71 (72, 73) viewed from a direction indicated by arrow A in FIG. 4A and FIG. 4C a side view of the optically rotatory member 71 (72, 73) viewed from a direction indicated by arrow B in FIG. 4A. Each optically rotatory member 71 (72, 73) may be one having continuously varying thicknesses in the circumferential direction around the optical axis AX (thicknesses in the optical-axis direction). In this case, as shown in FIG. 5, the thicknesses of the respective regions are assumed to be defined at centers of the respective regions 71a (72a, 73a) to 71r (72r, 73r).

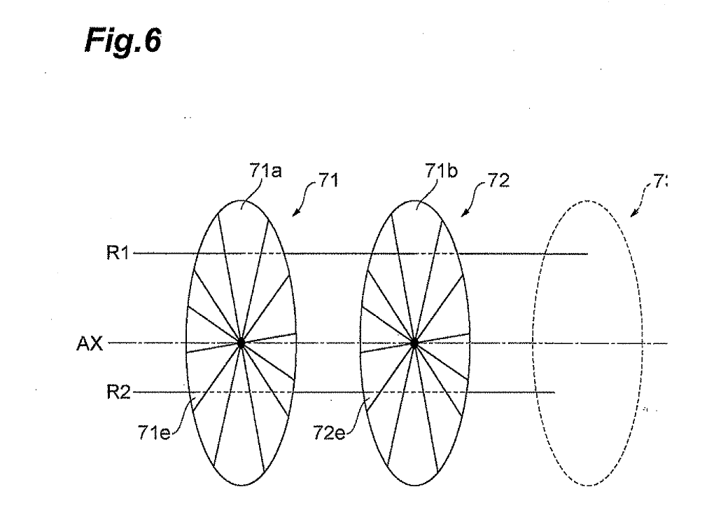

Polarization states of beams passing through the optically rotatory members 71-73 arranged as described above are different depending upon their passing positions. FIG. 6 is a drawing for explaining this. However, FIG. 6 is depicted mainly with focus on the relation between the first optically rotatory member 71 and the second optically rotatory member 72. Namely, as shown in FIG. 6, the sum (D1+D1) of respective thicknesses of the region 71a of the first optically rotatory member 71 and the region 72a of the second optically rotatory member 72 through which a first reference axis R1 parallel to the optical axis AX passes is different from the sum (D5+D5) of respective thicknesses of the region 71e of the first optically rotatory member 71 and the region 72e of the second optically rotatory member 72 through which a second reference axis R2 parallel to the optical axis AX and different from the first reference axis R1 passes. This means that total propagation distances of beams in the optically rotatory members are different depending upon their passing positions and this enables the passing beams to be set in respective polarization states different depending upon their passing positions.

The optically rotatory member 71 (72, 73) is a single member integrally formed by etching one surface (entrance surface or exit surface) of a plane-parallel plate of quartz crystal. Specifically, one surface of the optically rotatory member 71 (72, 73) is formed in an uneven surface shape with sixteen linear steps extending radially from the center thereof. The other surface of the optically rotatory member 71 (72, 73) is formed in a planar shape. As described above, the optically rotatory member 71 (72, 73) has a thickness distribution varying in the circumferential direction. The thickness distribution of the optically rotatory member 71 (72, 73) is a distribution of thicknesses along the traveling direction of incident light (Y-direction coincident with the optical-axis direction), in a plane (XZ plane) perpendicular to the traveling direction of the incident light, which is a nonuniform distribution.

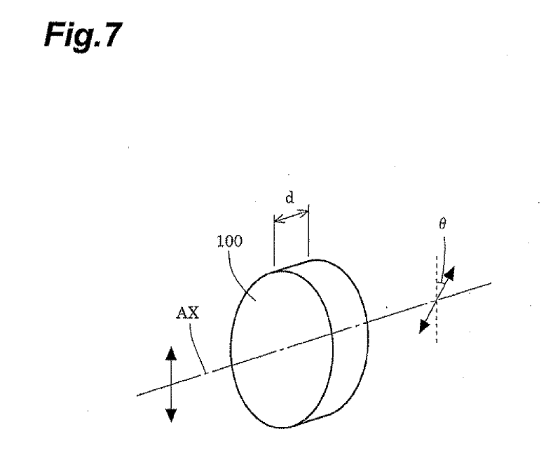

The optically rotatory members 71 to 73 have the same configuration and are arranged so that partition lines between mutually corresponding divided regions are superimposed when viewed from the traveling direction (Y-direction) of light. In another expression, the optically rotatory members 71, 72, and 73 are held so that their thickness distributions viewed from the traveling direction of light are in one-to-one correspondence on a region-by-region basis (i.e., so that regions with the same thickness are superimposed when viewed from the traveling direction of light). In still another expression, when the partition lines between the mutually corresponding divided regions of the optically rotatory members 71, 72, and 73 are projected along the traveling direction of light or the optical-axis direction onto a plane perpendicular to the direction, these partition lines are superimposed on each other. The below will briefly explain the optical activity of quartz crystal with reference to FIG. 7. With reference to FIG. 7, an optical member 100 of a plane-parallel plate shape of quartz crystal in a thickness d is arranged so that its crystal optic axis is coincident with the optical axis AX. In this case, linearly polarized light incident to the optical member 100 is emitted in a state in which the polarization direction thereof is rotated by θ around the optical axis AX, by virtue of the optical activity of the optical member 100.

At this time, the angle of rotation (optical rotatory angle) θ of the polarization direction due to the optical activity of the optical member 100 is represented by Eq (a) below, using the thickness d of the optical member 100 and the optical rotatory power ρ of quartz crystal. In general, the optical rotatory power ρ of quartz crystal has wavelength dependence (a property of varying the value of optical rotatory power dependent on the wavelength of used light: optical rotatory dispersion) and, specifically, it tends to increase with decrease in the wavelength of used light. According to the description on p 167 in Tadao Tsuruta, “Ouyou Kogaku (Applied Optics) II,” Baifukan (1990), the optical rotatory power p of quartz crystal for light with the wavelength of 250.3 nm is 153.9°/mm.

θ=d·ρ (a)

Referring again to FIG. 4A, the divided region 71a (72a, 73a) is arranged so that its center line (straight line extending in a radial direction of a circle centered on the optical axis AX, from the optical axis AX) is coincident with a straight line extending across the optical axis AX in the +X-direction. This divided region 71a (72a, 73a) has the thickness D1 set so that when Z-directionally linearly polarized light with the polarization direction along the Z-direction is incident thereto, it emits linearly polarized light with the polarization direction along a direction resulting from +60° (60° counterclockwise in FIG. 4A) rotation of the Z-direction. The divided region 71b (72b, 73b) adjacent to the divided region 71a (72a, 73a) along the counterclockwise circumferential direction in FIG. 4A has the thickness D2 set so that when the Z-directionally linearly polarized light is incident thereto, it emits linearly polarized light with the polarization direction along a direction resulting from +7.5° rotation of the Z-direction.

The divided region 71c (72c, 73c) adjacent to the divided region 71b (72b, 73b) has the thickness D3 set so that when the Z-directionally linearly polarized light is incident thereto, it emits linearly polarized light with the polarization direction along a direction resulting from +15° rotation of the Z-direction. The divided region 71d (72d, 73d) adjacent to the divided region 71c (72c, 73e) has the thickness D4 set so that when the Z-directionally linearly polarized light is incident thereto, it emits linearly polarized light with the polarization direction along a direction resulting from +22.5° rotation of the Z-direction. The divided region 71e (72e, 73e) adjacent to the divided region 71d (72d, 73d) has the thickness D5 set so that when the Z-directionally linearly polarized light is incident thereto, it emits linearly polarized light with the polarization direction along a direction resulting from +30° rotation of the Z-direction.

The divided region 71f (72f, 73f) adjacent to the divided region 71e (72e, 73e) has the thickness D6 set so that when the Z-directionally linearly polarized light is incident thereto, it emits linearly polarized light with the polarization direction along a direction resulting from +37.5° rotation of the Z-direction. The divided region 71g (72g, 73g) adjacent to the divided region 711 (72f, 73f) has the thickness D7 set so that when the Z-directionally linearly polarized light is incident thereto, it emits linearly polarized light with the polarization direction along a direction resulting from +45° rotation of the Z-direction. The divided region 71h (72h, 73h) adjacent to the divided region 71g (72g, 73g) has the thickness D8 set so that when the Z-directionally linearly polarized light is incident thereto, it emits linearly polarized light with the polarization direction along a direction resulting from +52.5° rotation of the Z-direction.

The divided region 71i (72i, 73i) adjacent to the divided region 71h (72h, 73h) and opposed to the divided region 71a (72a, 73a) with the optical axis AX in between has the thickness D1 set so that when the Z-directionally linearly polarized light is incident thereto, it emits linearly polarized light with the polarization direction along a direction resulting from +60° rotation of the Z-direction as the divided region 71a (72a, 73a) does. The divided region 71j (72j, 73j) opposed to the divided region 71b (72b, 73b) has the thickness D2 set so that when the Z-directionally linearly polarized light is incident thereto, it emits linearly polarized light with the polarization direction along a direction resulting from +7.5° rotation of the Z-direction. The divided region 71k (72k, 73k) opposed to the divided region 71c (72c, 73c) has the thickness D3 set so that when the Z-directionally linearly polarized light is incident thereto, it emits linearly polarized light with the polarization direction along a direction resulting from +15° rotation of the Z-direction.

The divided region 71m (72m, 73m) opposed to the divided region 71d (72d, 73d) has the thickness D4 set so that when the Z-directionally linearly polarized light is incident thereto, it emits linearly polarized light with the polarization direction along a direction resulting from +22.5° rotation of the Z-direction. The divided region 71n (72n, 73n) opposed to the divided region 71e (72e, 73e) has the thickness D5 set so that when the Z-directionally linearly polarized light is incident thereto, it emits linearly polarized light with the polarization direction along a direction resulting from +30° rotation of the Z-direction. The divided region 71p (72p, 73p) opposed to the divided region 71f (72f, 73f) has the thickness D6 set so that when the Z-directionally linearly polarized light is incident thereto, it emits linearly polarized light with the polarization direction along a direction resulting from +37.5° rotation of the Z-direction.

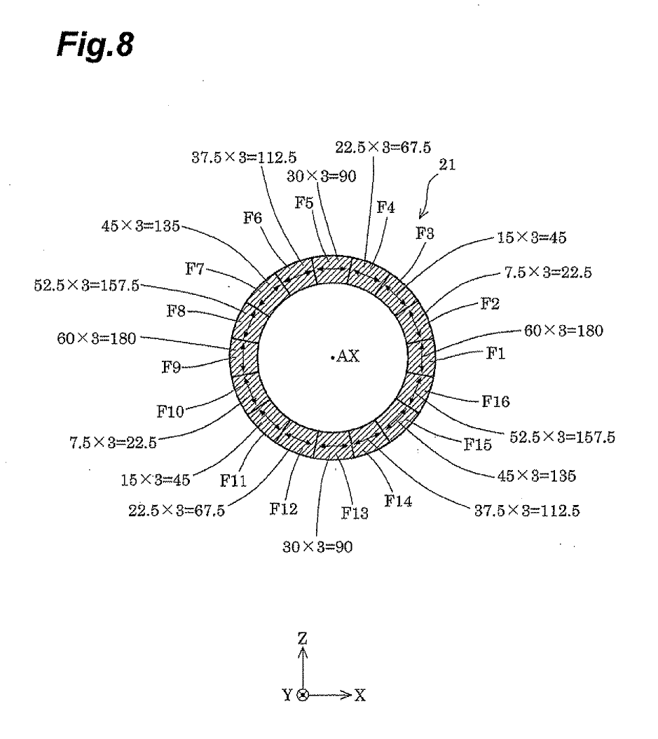

The divided region 71q (72q, 73q) opposed to the divided region 71g (72g, 73g) has the thickness D7 set so that when the Z-directionally linearly polarized light is incident thereto, it emits linearly polarized light with the polarization direction along a direction resulting from +45° rotation of the Z-direction. The divided region 71r (72r, 73r) opposed to the divided region 71h (72h, 73h) has the thickness D8 set so that when the Z-directionally linearly polarized light is incident thereto, it emits linearly polarized light with the polarization direction along a direction resulting from +52.5° rotation of the Z-direction. The action of the polarization converting unit 7 will be described below with reference to FIG. 8 on the assumption that the Z-directionally linearly polarized light is incident into the first optically rotatory member 71 (therefore, into the polarization converting unit 7).

When attention is focused on light with an arcuate cross section incident into the divided region 71a of the optically rotatory member 71, a beam F1, which is light generated through successive passage through the divided regions 72a, 73a of the optically rotatory members 72, 73, is Z-directionally linearly polarized light with the polarization direction along a direction resulting from +180° (180° counterclockwise in FIG. 8) rotation of the Z-direction, i.e., along the Z-direction. The composite rotation angle of the divided regions 71a, 72a, and 73a herein, 180°, is nothing but the sum of 60° being the rotation angle of the divided region 71a, 60° being the rotation angle of the divided region 72a, and 60° being the rotation angle of the divided region 73a. Similarly, a beam F2 generated through the divided regions 71b to 73b of the optically rotatory members 71 to 73 is linearly polarized light with the polarization direction along a direction resulting from +22.5° rotation of the Z-direction.

A beam F3 generated through the divided regions 71c-73c of the optically rotatory members 71-73 is linearly polarized light with the polarization direction along a direction resulting from +45° rotation of the Z-direction. A beam F4 generated through the divided regions 71d-73d of the optically rotatory members 71-73 is linearly polarized light with the polarization direction along a direction resulting from +67.5° rotation of the Z-direction. A beam F5 generated through the divided regions 71e-73e of the optically rotatory members 71-73 is X-directionally linearly polarized light with the polarization direction along a direction resulting from +90° rotation of the Z-direction, i.e., along the X-direction. A beam F6 generated through the divided regions 71f-73f of the optically rotatory members 71-73 is linearly polarized light with the polarization direction along a direction resulting from +112.5° rotation of the Z-direction.

A beam F7 generated through the divided regions 71g-73g of the optically rotatory members 71-73 is linearly polarized light with the polarization direction along a direction resulting from +135° rotation of the Z-direction. A beam F8 generated through the divided regions 71h-73h of the optically rotatory members 71-73 is linearly polarized light with the polarization direction along a direction resulting from +157.5° rotation of the Z-direction. A beam F9 generated through the divided regions 71i-73i of the optically rotatory members 71-73 is Z-directionally linearly polarized light with the polarization direction along a direction resulting from +180° rotation of the Z-direction, i.e., along the Z-direction as the beam F1 opposed thereto with the optical axis AX in between is.

A beam F10 generated through the divided regions 71j-73j of the optically rotatory members 71-73 is linearly polarized light with the polarization direction along a direction resulting from +22.5° rotation of the Z-direction as the beam F2 opposed thereto with the optical axis AX in between is. A beam F11 generated through the divided regions 71k-73k of the optically rotatory members 71-73 is linearly polarized light with the polarization direction along a direction resulting from +45° rotation of the Z-direction as the beam F3 opposed thereto with the optical axis AX in between is. A beam F12 generated through the divided regions 71m-73m of the optically rotatory members 71-73 is linearly polarized light with the polarization direction along a direction resulting from +67.5° rotation of the Z-direction as the beam F4 opposed thereto with the optical axis AX in between is.

A beam F13 generated through the divided regions 71n-73n of the optically rotatory members 71-73 is X-directionally linearly polarized light with the polarization direction along a direction resulting from +90° rotation of the Z-direction, i.e., along the X-direction as the beam F5 opposed thereto with the optical axis AX in between is. A beam F14 generated through the divided regions 71p-73p of the optically rotatory members 71-73 is linearly polarized light with the polarization direction along a direction resulting from +112.5° rotation of the Z-direction as the beam F6 opposed thereto with the optical axis AX in between is. A beam F15 generated through the divided regions 71q-73q of the optically rotatory members 71-73 is linearly polarized light with the polarization direction along a direction resulting from +135′ rotation of the Z-direction as the beam F7 opposed thereto with the optical axis AX in between is. A beam F 16 generated through the divided regions 71r-73r of the optically rotatory members 71-73 is linearly polarized light with the polarization direction along a direction resulting from +157.5′ rotation of the Z-direction as the beam F8 opposed thereto with the optical axis AX in between is.

In this manner, an annular light intensity distribution 21 is formed in a circumferentially polarized state with high continuity of a sixteen-equal-division type on the illumination pupil immediately after the second polarization converting member 7. In the circumferentially polarized state, a beam passing through the annular light intensity distribution 21 becomes linearly polarized light with the polarization direction along a tangent direction to a circle centered on the optical axis AX. As a result, an annular light intensity distribution is formed in a substantially continuous, circumferentially polarized state corresponding to the annular light intensity distribution 21, on the illumination pupil immediately after the micro fly's eye lens 10. Furthermore, an annular light intensity distribution is also formed in a substantially continuous, circumferentially polarized state corresponding to the annular light intensity distribution 21, at positions of other illumination pupils optically conjugate with the illumination pupil immediately after the micro fly's eye lens 10, i.e., at the pupil position of the imaging optical system 13 and at the pupil position of the projection optical system PL (position where the aperture stop AS is located).

In general, in the case of circumferential polarization illumination based on the pupil intensity distribution of the annular shape or multi-polar shape (dipolar, quadrupolar, octupolar, or other shape) in the circumferentially polarized state, the light impinging upon the wafer W as a final illumination target surface is in a polarized state in which the major component is s-polarized light. The s-polarized light herein is linearly polarized light having the polarization direction along a direction perpendicular to a plane of incidence (polarized light whose electric vector is vibrating in the direction perpendicular to the plane of incidence). It is noted herein that the plane of incidence is a plane defined as follows: when light arrives at a boundary surface (illumination target surface: surface of the wafer W) of a medium, a plane including a normal to the boundary plane at that point and a direction of incidence of the light is defined as the plane of incidence. As a result, the circumferential polarization illumination permits improvement in optical performance (depth of focus and others) of the projection optical system and provides a mask pattern image with high contrast on the wafer (photosensitive substrate).

As described above, the polarization converting unit 7 forms the light intensity distribution 21 in the circumferentially polarized state with high continuity of the sixteen-equal-division type on the illumination pupil immediately after the unit 7 by cooperative action of the three optically rotatory members 71-73 (each having the same structure) arranged in the adjacent state along the optical axis AX. The optically rotatory members 71-73 each have the sixteen divided regions 71a, 72a, 73a to 71r, 72r, 73r resulting from the equal division in the circumferential direction around the optical axis AX (which is a circumferential direction of a circle centered on the optical axis AX on a plane perpendicular to the optical axis; this will also apply to the description hereinafter) and are arranged so that the partition lines between the corresponding divided regions are superimposed when viewed from the traveling direction of light. Therefore, a difference between a maximum rotation angle (60° in the above example) and a minimum rotation angle (7.5° in the above example) required of the divided regions for achievement of the circumferentially polarized state, i.e., a required rotation angle range is kept relatively small.

This means that in manufacture of the optically rotatory members 71-73 as single members integrally formed by etching one surface of a plane-parallel plate of quartz crystal, a maximum processing depth (maximum of depths to be etched in the thickness direction of the plane-parallel plate) required for formation of the required uneven surface shape is kept relatively small. In other words, since the maximum processing depth required for formation of the required uneven surface shape is kept relatively small, it becomes feasible to readily manufacture the optically rotatory members 71-73 as integrally formed single members, by etching one surface of a plane-parallel plate of quartz crystal.

As a result, the polarization converting unit 7 of the present embodiment, different from the conventional technology described in U.S. Patent Application Laid-Open No. 2006/0170901, has no need for preparing members as many as the number of divisions in the circumferential direction and no need for accurately arranging and holding these members along in-plane directions. For this reason, the difficulty of manufacture of the optically rotatory members 71-73 (and therefore the polarization converting unit 7) is less likely to become higher, even with increase in the number of divisions for achievement of the circumferentially polarized state with high continuity. Namely, the polarization converting unit 7 of the present embodiment has the configuration relatively easy to manufacture and is able to achieve the pupil intensity distribution in the circumferentially polarized state with high continuity when arranged in the optical path of the illumination optical system (2-13).

The illumination optical system (2-13) of the present embodiment is able to illuminate the pattern surface (illumination target surface) of the mask M with the light in the desired circumferentially polarized state, using the polarization converting unit 7 achieving the annular pupil intensity distribution in the circumferentially polarized state with high continuity. The exposure apparatus (2-WS) of the present embodiment is able to accurately transfer the microscopic pattern onto the wafer W while suitably fulfilling the operational advantage of the circumferential polarization under an appropriate illumination condition achieved according to a characteristic of the pattern of the mask M to be transferred, using the illumination optical system (2-13) to illuminate the pattern surface of the mask M with the light in the desired circumferentially polarized state.

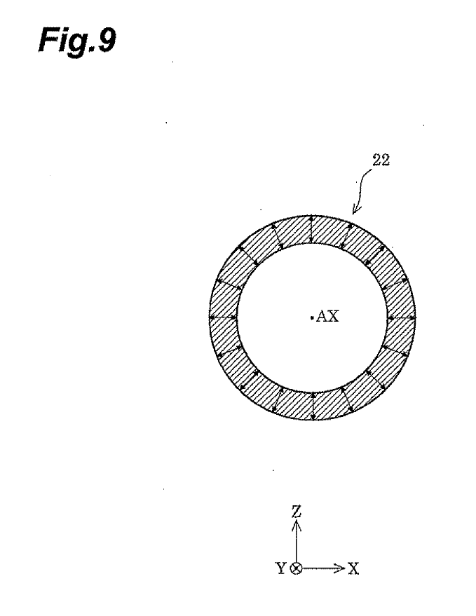

In the above-described embodiment the Z-directionally linearly polarized light is made incident to the polarization converting unit 7, whereas in a case where X-directionally linearly polarized light is made incident to the polarization converting unit 7, an annular light intensity distribution 22 in a radially polarized state with high continuity of the sixteen-equal-division type is formed on the illumination pupil immediately after the polarization converting unit 7, as shown in FIG. 9. As a consequence, an annular light intensity distribution is also formed in a substantially continuous, radially polarized state corresponding to the annular light intensity distribution 22, at the illumination pupil immediately after the micro fly's eye lens 10, at the pupil position of the imaging optical system 13, and at the pupil position of the projection optical system PL.

In general, in the case of the radial polarization illumination based on the annular or multi-polar pupil intensity distribution in the radially polarized state, the light impinging upon the wafer W as a final illumination target surface is in a polarization state in which the major component is p-polarized light. The p-polarized light herein is linearly polarized light having the polarization direction along a direction parallel to the plane of incidence defined as described above (i.e., polarized light whose electric vector is vibrating in the direction parallel to the plane of incidence). As a result, the radial polarization illumination provides a good mask pattern image on the wafer (photosensitive substrate) while keeping the reflectance of light small on a resist applied on the wafer W.

The above embodiment described the polarization converting unit 7 having the specific configuration shown in FIGS. 3 and 4. However, various forms can be contemplated as to the configuration of the polarization converting unit. Specifically, a variety of forms can be contemplated as to the arrangement position of the polarization converting unit, the number of optically rotatory members, the material of the optically rotatory members, the configuration of the optically rotatory members (differences in the contour, the surface shape (thickness distribution), the side where the uneven surface is formed, the number of uneven surfaces, and so on), the arrangement relation among the optically rotatory members, the processing technique of the optically rotatory members, and so on (e.g., cf FIG. 5).

For example, in the foregoing embodiment, the polarization converting unit 7 is arranged at or near the pupil position of the afocal lens 6. However, without having to be limited to this, the polarization converting unit 7 may be arranged at a position of another illumination pupil or at a position near it in the illumination optical system (2-13). Specifically, the polarization converting unit 7 can also be arranged near the entrance plane of the micro fly's eye lens 10, near the exit plane of the micro fly's eye lens 10, at or near the pupil position of the imaging optical system 13, and so on.

In the foregoing embodiment, the optically rotatory members 71-73 are formed by etching one surface of a plane-parallel plate of quartz crystal. However, without having to be limited to this, the optically rotatory members can also be made of an optical material with an optical activity except for the quartz crystal. Furthermore, the optically rotatory members can also be made by an appropriate processing technique other than the etching. The optically rotatory members can also be formed by processing the both surfaces of the plane-parallel plate. In this case, the maximum processing depth required of each surface is half of the maximum processing depth in the above embodiment.

In the above embodiment the optically rotatory members 71-73 have the sixteen divided regions resulting from the equal division in the circumferential direction around the optical axis AX, but the number of divided regions is not limited to 16 but may be 2, 4, 8, or 32. Furthermore, the division does not always have to be the equal division. The optically rotatory members 71-73 do not always have to be limited to the configuration with the plurality of divided regions resulting from the division in the circumferential direction, but each member may be constructed, for example, in a configuration wherein each of the divided regions is polygonal (typically, a shape enabling closest packing such as a rectangular, hexagonal, or other shape) and wherein these divided regions are two-dimensionally arranged along the arrangement plane of the optically rotatory member.

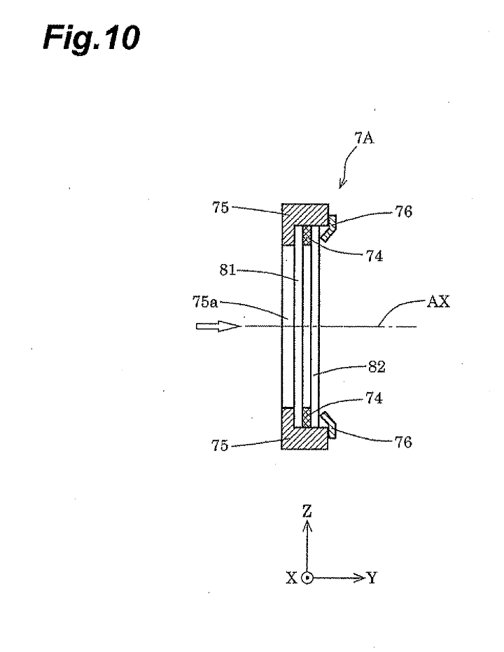

In the above embodiment the polarization converting unit 7 has the three optically rotatory members 71-73. However, without having to be limited to this, it is also possible to construct a polarization converting unit 7A of two optically rotatory members 81, 82 as shown in FIG. 10, for example. The polarization converting unit 7A of the modification example has the first optically rotatory member 81 and the second optically rotatory member 82 in order from the entrance side of light (light source side; left in FIG. 10).

It is assumed hereinafter for simplicity of description that the optically rotatory members 81, 82 are members corresponding to the optically rotatory members 71, 72 in the above embodiment and have the same structure and thickness distribution as the optically rotatory members 71, 72. Furthermore, the optically rotatory members 81 and 82 are assumed to be arranged so that the partition lines between the mutually corresponding divided regions are superimposed when viewed from the traveling direction of light (Y-direction), like the positional relationship between the optically rotatory members 71 and 72. However, the optically rotatory members 81, 82, different from the optically rotatory members 71, 72, are single members integrally formed by etching both surfaces (entrance surface and exit surface) of a plane-parallel plate of quartz crystal.

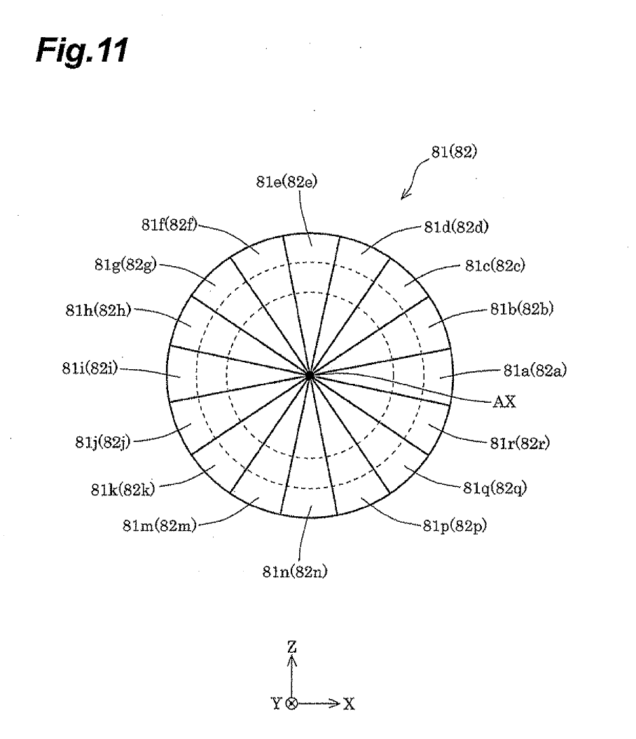

The optically rotatory member 81 (82), as shown in FIG. 11, has a contour of a circular shape centered on the optical axis AX (or an annular shape not illustrated) and has sixteen divided regions obtained by dividing the circular shape into sixteen equal regions along the circumferential direction around the optical axis AX. Specifically, the optically rotatory member 81 (82) has, as the sixteen divided regions, regions 81a (82a), 81b (82b), 81c (82c), 81d (82d), 81e (82e), 81f (82f), 81g (82g), 81h (82h), 81i (82i), 81j (82j), 81k (82k), 81m (82m), 81n h (82n), 81p (82p), 81q (82q), and 81r (82r).

The divided region 81a (82a) has the thickness D1 set so that when the Z-directionally linearly polarized light with the polarization direction along the Z-direction is incident thereto, it emits X-directionally linearly polarized light with the polarization direction along a direction resulting from +90° (90° counterclockwise in FIG. 11) rotation of the Z-direction, i.e., along the X-direction. The divided region 81b (82b) adjacent to the divided region 81a (82a) along the counterclockwise circumferential direction in FIG. 11 has the thickness D2 set so that when the Z-directionally linearly polarized light is incident thereto, it emits linearly polarized light with the polarization direction along a direction resulting from +11.25° rotation of the Z-direction.

The divided region 81c (82c) adjacent to the divided region 81b (82b) has the thickness D3 set so that when the Z-directionally linearly polarized light is incident thereto, it emits linearly polarized light with the polarization direction along a direction resulting from +22.5° rotation of the Z-direction. The divided region 81d (82d) adjacent to the divided region 81c (82e) has the thickness D4 set so that when the Z-directionally linearly polarized light is incident thereto, it emits linearly polarized light with the polarization direction along a direction resulting from +33.75° rotation of the Z-direction. The divided region 81e (82e) adjacent to the divided region 81d (82d) has the thickness D5 set so that when the Z-directionally linearly polarized light is incident thereto, it emits linearly polarized light with the polarization direction along a direction resulting from +45° rotation of the Z-direction.

The divided region 81f (82f) adjacent to the divided region 81e (82e) has the thickness D6 set so that when the Z-directionally linearly polarized light is incident thereto, it emits linearly polarized light with the polarization direction along a direction resulting from +56.25° rotation of the Z-direction. The divided region 81g (82g) adjacent to the divided region 81f (82f) has the thickness D7 set so that when the Z-directionally linearly polarized light is incident thereto, it emits linearly polarized light with the polarization direction along a direction resulting from +67.5° rotation of the Z-direction. The divided region 81h (82h) adjacent to the divided region 81g (82g) has the thickness D8 set so that when the Z-directionally linearly polarized light is incident thereto, it emits linearly polarized light with the polarization direction along a direction resulting from +78.75° rotation of the Z-direction.

The divided region 81i (82i) adjacent to the divided region 81h (82h) and opposed to the divided region 81a (82a) with the optical axis AX in between has the thickness D1 set so that when the Z-directionally linearly polarized light is incident thereto, it emits X-directionally linearly polarized light with the polarization direction along a direction resulting from +90° rotation of the Z-direction, i.e., along the X-direction as the divided region 81a (82a) does. The divided region 81j (82j) opposed to the divided region 81b (82b) has the thickness D2 set so that when the Z-directionally linearly polarized light is incident thereto, it emits linearly polarized light with the polarization direction along a direction resulting from +11.25° rotation of the Z-direction. The divided region 81k (82k) opposed to the divided region 81c (82c) has the thickness D3 set so that when the Z-directionally linearly polarized light is incident thereto, it emits linearly polarized light with the polarization direction along a direction resulting from +22.5° rotation of the Z-direction.

The divided region 81m (82m) opposed to the divided region 81d (82d) has the thickness D4 set so that when the Z-directionally linearly polarized light is incident thereto, it emits linearly polarized light with the polarization direction along a direction resulting from +33.75° rotation of the Z-direction. The divided region 81n (82n) opposed to the divided region 81e (82e) has the thickness D5 set so that when the Z-directionally linearly polarized light is incident thereto, it emits linearly polarized light with the polarization direction along a direction resulting from +45° rotation of the Z-direction. The divided region 81p (82p) opposed to the divided region 81f (82f) has the thickness D6 set so that when the Z-directionally linearly polarized light is incident thereto, it emits linearly polarized light with the polarization direction along a direction resulting from +56.25° rotation of the Z-direction.

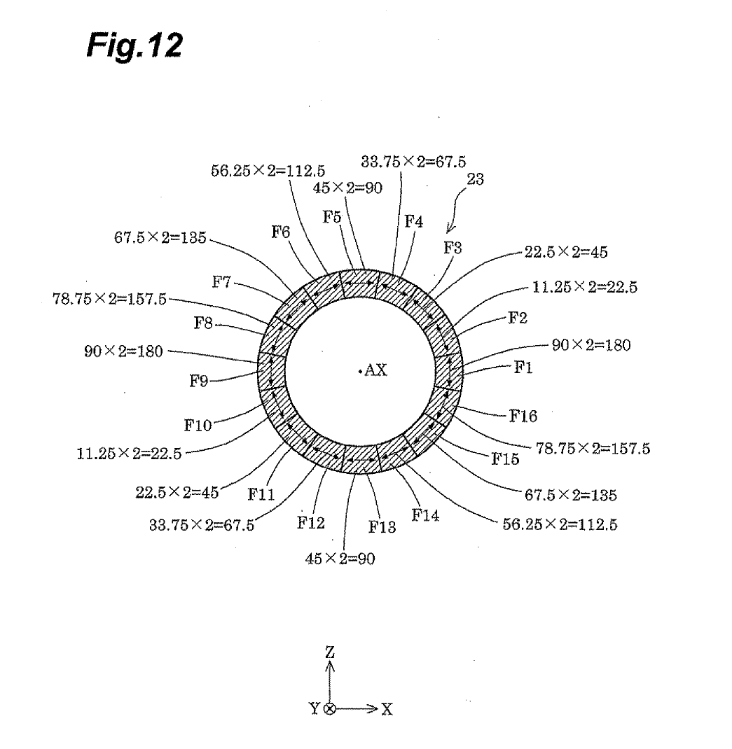

The divided region 81q (82q) opposed to the divided region 81g (82g) has the thickness D7 set so that when the Z-directionally linearly polarized light is incident thereto, it emits linearly polarized light with the polarization direction along a direction resulting from +67.5° rotation of the Z-direction. The divided region 81r (82r) opposed to the divided region 81h (82h) has the thickness D8 set so that when the Z-directionally linearly polarized light is incident thereto, it emits linearly polarized light with the polarization direction along a direction resulting from +78.75° rotation of the Z-direction. The below will describe the action of the polarization converting unit 7A with reference to FIG. 12, on the assumption that the Z-directionally linearly polarized light is incident into the first optically rotatory member 81 (therefore, into the polarization converting unit 7A).

When attention is focused on light with an arcuate cross section incident into the divided region 81a of the optically rotatory member 81, a beam F1, which is light generated through the divided region 82a of the optically rotatory member 82, is Z-directionally linearly polarized light with the polarization direction along a direction resulting from +180° (180° counterclockwise in FIG. 12) rotation of the Z-direction, i.e., along the Z-direction. The composite rotation angle of the divided regions 81a and 82a, 180°, is nothing but the sum of 90° being the rotation angle of the divided region 81 a and 90° being the rotation angle of the divided region 82a. Similarly, a beam F2 generated through the divided regions 81b, 82b of the optically rotatory members 81, 82 is linearly polarized light with the polarization direction along a direction resulting from +22.5° rotation of the Z-direction.

A beam F3 generated through the divided regions 81c, 82c of the optically rotatory members 81, 82 is linearly polarized light with the polarization direction along a direction resulting from +45° rotation of the Z-direction. A beam F4 generated through the divided regions 81d, 82d of the optically rotatory members 81, 82 is linearly polarized light with the polarization direction along a direction resulting from +67.5° rotation of the Z-direction. A beam F5 generated through the divided regions 81e, 82e of the optically rotatory members 81, 82 is X-directionally linearly polarized light with the polarization direction along a direction resulting from +90° rotation of the Z-direction, i.e., along the X-direction. A beam F6 generated through the divided regions 81f, 82f of the optically rotatory members 81, 82 is linearly polarized light with the polarization direction along a direction resulting from +112.5° rotation of the Z-direction.

A beam F7 generated through the divided regions 81g, 82g of the optically rotatory members 81, 82 is linearly polarized light with the polarization direction along a direction resulting from +135° rotation of the Z-direction. A beam F8 generated through the divided regions 81h, 82h of the optically rotatory members 81, 82 is linearly polarized light with the polarization direction along a direction resulting from +157.5° rotation of the Z-direction. A beam F9 generated through the divided regions 81i, 82i of the optically rotatory members 81, 82 is Z-directionally linearly polarized light with the polarization direction along a direction resulting from +180° rotation of the Z-direction, i.e., along the Z-direction as the beam F1 opposed thereto with the optical axis AX in between is.

A beam F10 generated through the divided regions 81j, 82j of the optically rotatory members 81, 82 is linearly polarized light with the polarization direction along a direction resulting from +22.5° rotation of the Z-direction as the beam F2 opposed thereto with the optical axis AX in between is. A beam F11 generated through the divided regions 81k, 82k of the optically rotatory members 81, 82 is linearly polarized light with the polarization direction along a direction resulting from +45° rotation of the Z-direction as the beam F3 opposed thereto with the optical axis AX in between is. A beam F12 generated through the divided regions 81m, 82m of the optically rotatory members 81, 82 is linearly polarized light with the polarization direction along a direction resulting from +67.5° rotation of the Z-direction as the beam F4 opposed thereto with the optical axis AX in between is.

A beam F13 generated through the divided regions 81n, 82n of the optically rotatory members 81, 82 is X-directionally linearly polarized light with the polarization direction along a direction resulting from +90° rotation of the Z-direction, i.e., along the X-direction as the beam F5 opposed thereto with the optical axis AX in between is. A beam F14 generated through the divided regions 81p, 82p of the optically rotatory members 81, 82 is linearly polarized light with the polarization direction along a direction resulting from +112.5° rotation of the Z-direction as the beam F6 opposed thereto with the optical axis AX in between is. A beam F15 generated through the divided regions 81q, 82q of the optically rotatory members 81, 82 is linearly polarized light with the polarization direction along a direction resulting from +135° rotation of the Z-direction as the beam F7 opposed thereto with the optical axis AX in between is. A beam F16 generated through the divided regions 81r, 82r of the optically rotatory members 81, 82 is linearly polarized light with the polarization direction along a direction resulting from +157.5° rotation of the Z-direction as the beam F8 opposed thereto with the optical axis AX in between is.

In this manner, an annular light intensity distribution 23 is formed in a circumferentially polarized state with high continuity of the sixteen-equal-division type on the illumination pupil immediately after the polarization converting unit 7A. If X-directionally linearly polarized light is incident into the polarization converting unit 7A, which is not shown, an annular light intensity distribution is formed in a radially polarized state with high continuity of the sixteen-equal-division type on the illumination pupil immediately after it (cf. FIG. 9). Since the polarization converting unit 7A is composed of the two optically rotatory members 81, 82, the required rotation angle range, which is the difference between the maximum rotation angle (90° in the above example) and the minimum rotation angle (11.25° in the above example) required of each optically rotatory member 81, 82 for achievement of the circumferentially polarized state, is larger than the rotation angle range required of each optically rotatory member 71-73 of the polarization converting unit 7 composed of the three optically rotatory members 71-73.

However, since the optically rotatory members 81, 82 are formed by etching the both surfaces of the plane-parallel plate, the required maximum processing depth in the optically rotatory members 81, 82 is smaller than the required maximum processing depth in the optically rotatory members 71-73 obtained by etching only one surface. It is noted that the optically rotatory members with the same polarization conversion property as the optically rotatory members 81, 82 can also be formed by processing one surface of a plane-parallel plate. In that case, however, the maximum processing depth required of each optically rotatory member becomes double the maximum processing depth in the above modification example.

In the optically rotatory members 81, 82 in the above modification example, as in the case of the optically rotatory members 71-73 in the aforementioned embodiment, the number of divided regions is not limited to 16, but may be 2, 4, 8, or 32. The division does not always have to be the equal division. The configuration of the optically rotatory members 81, 82 does not have to be limited to the configuration with the plurality of divided regions resulting from the circumferential division, but each member may be constructed, for example, in a configuration wherein each divided region is polygonal (typically, a shape enabling closest packing such as a rectangular, hexagonal, or other shape) and wherein these divided regions are two-dimensionally arranged along the arrangement plane of the optically rotatory member.

In the above embodiment and modification example, the plurality of optically rotatory members (71-73; 81 and 82) are arranged so as to be adjacent along the optical axis AX. However, without having to be limited to this, it is also possible to adopt a configuration with a relay optical system for making one optically rotatory member and another optically rotatory member out of the plurality of optically rotatory members optically conjugate with each other.

In the above embodiment and modification example, of the plurality of divided regions resulting from the circumferential division around the optical axis AX in the optically rotatory members (71-73; 81, 82), any two regions adjacent to each other have the thicknesses different from each other. In other words, the optically rotatory members (71-73; 81, 82) have the thickness distribution of thicknesses varying stepwise (discontinuously) along the circumferential direction around the optical axis AX. However, without having to be limited to this, it is also possible to construct the polarization converting unit of optically rotatory members with a thickness distribution continuously varying in the circumferential direction around the optical axis AX (cf. FIG. 5).

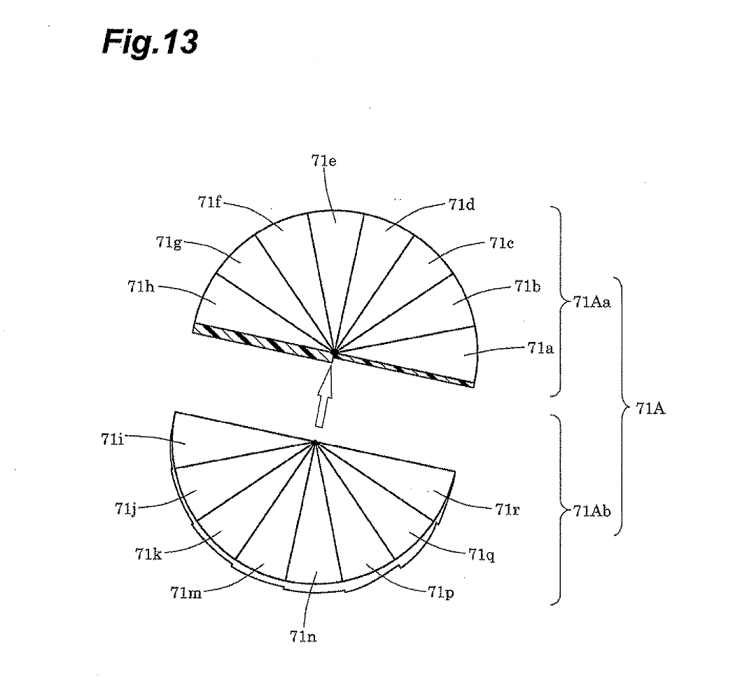

In the above embodiment and modification example, the optically rotatory members (71-73; 81, 82) are constructed of the integrally formed single members. However, without having to be limited to this, it is also possible to construct an optically rotatory member 71 A having a configuration corresponding to the first optically rotatory member 71 in the above embodiment, of a first divided member 71Aa integrally formed and a second divided member 71Ab integrally formed, for example, as shown in FIG. 13.

The above description concerned the description of the operational advantage of the embodiment using the modified illumination to form the annular pupil intensity distribution on the illumination pupil, i.e., the annular illumination as an example. However, without having to be limited to the annular illumination, it is apparent that the same operational advantage can also be achieved similarly by application of the embodiment, for example, to multi-polar illumination to form a multi-polar pupil intensity distribution.

In the foregoing embodiment, the micro fly's eye lens 10 was used as an optical integrator, but an optical integrator of an internal reflection type (typically, a rod type integrator) may be used instead thereof. In this case, a condensing optical system for condensing the light from the predetermined plane IP is arranged in place of the zoom lens 9. Furthermore, instead of the micro fly's eye lens 10 and the condenser optical system 11, the rod type integrator is arranged so that an entrance end thereof is positioned at or near the rear focus position of the condensing optical system for condensing the light from the predetermined plane IP. At this time, an exit end of the rod type integrator is at the position of the mask blind 12. In the use of the rod type integrator, a position optically conjugate with the position of the aperture stop AS of the projection optical system PL, in the imaging optical system 13 downstream the rod type integrator can be called an illumination pupil plane. Since a virtual image of the secondary light source on the illumination pupil plane is formed at the position of the entrance plane of the rod type integrator, this position and positions optically conjugate therewith can also be called illumination pupil planes. The condensing optical system, the imaging optical system, and the rod type integrator can be regarded as a distribution forming optical system.

In the aforementioned embodiment, the mask can be replaced with a variable pattern forming device which forms a predetermined pattern on the basis of predetermined electronic data. The variable pattern forming device applicable herein can be, for example, a DMD (Digital Micromirror Device) including a plurality of reflective elements driven based on predetermined electronic data. The exposure apparatus with the DMD is disclosed, for example, in Japanese Patent Application Laid-Open No. 2004-304135, and U.S. Patent Application Laid-Open No. 2007/0296936 (corresponding to International Publication No, 2006/080285). Besides the reflection type spatial light modulators of the non-emission type like the DMD, it is also possible to apply a transmission type spatial light modulator or a self-emission type image display device. The teachings of U.S. Patent Application Laid-Open No. 2007/0296936 (corresponding to International Publication No. 2006/080285) are incorporated herein by reference.

The exposure apparatus of the foregoing embodiment is manufactured by assembling various sub-systems containing their respective components as set forth in the scope of claims in the present application, so as to maintain predetermined mechanical accuracy, electrical accuracy, and optical accuracy. For ensuring these various accuracies, the following adjustments are carried out before and after the assembling: adjustment for achieving the optical accuracy for various optical systems; adjustment for achieving the mechanical accuracy for various mechanical systems; adjustment for achieving the electrical accuracy for various electrical systems. The assembling from the various sub-systems into the exposure apparatus includes mechanical connections, wire connections of electric circuits, pipe connections of pneumatic circuits, etc. between the various sub-systems. It is needless to mention that there are assembling of the individual sub-systems, before the assembling steps from the various sub-systems into the exposure apparatus. After completion of the assembling from the various sub-systems into the exposure apparatus, overall adjustment is carried out to ensure various accuracies as the entire exposure apparatus. The manufacture of the exposure apparatus may be carried out in a clean room in which the temperature, cleanliness, etc. are controlled.

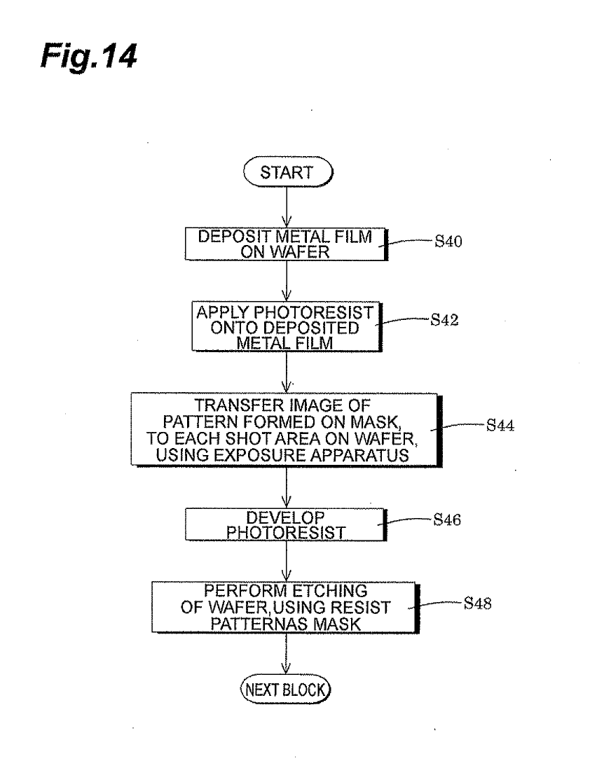

The following will describe a device manufacturing method using the exposure apparatus according to the above-described embodiment. FIG. 14 is a flowchart showing manufacturing blocks of semiconductor devices. As shown in FIG. 14, the manufacturing blocks of semiconductor devices include depositing a metal film on a wafer W to become a substrate of semiconductor devices (block S40) and applying a photoresist as a photosensitive material onto the deposited metal film (block S42). The subsequent blocks include transferring a pattern formed on a mask (reticle) M, onto each of shot areas on the wafer W, using the exposure apparatus of the above embodiment (block S44: exposure block), and developing the wafer W after completion of the transfer, i.e., developing the photoresist to which the pattern is transferred (block S46: development block).

Thereafter, using the resist pattern made on the surface of the wafer W in block S46, as a mask, processing such as etching is carried out on the surface of the wafer W (block S48: processing block). The resist pattern herein is a photoresist layer in which depressions and projections are formed in a shape corresponding to the pattern transferred by the exposure apparatus of the above embodiment and which the depressions penetrate throughout. Block S48 is to process the surface of the wafer W through this resist pattern. The processing carried out in block S48 includes, for example, at least either etching of the surface of the wafer W or deposition of a metal film or the like.

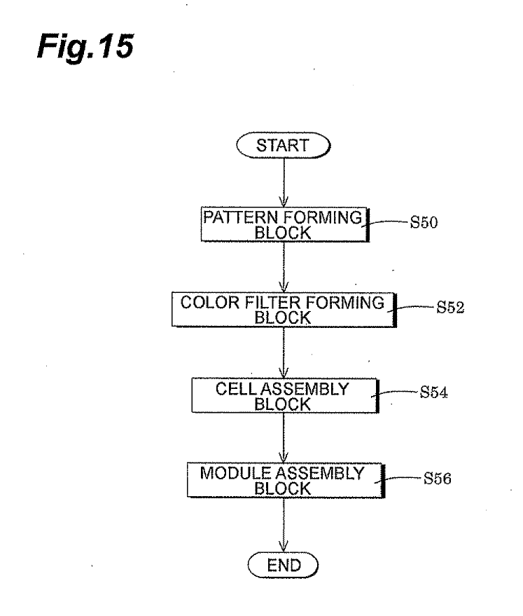

FIG. 15 is a flowchart showing manufacturing blocks of a liquid crystal device such as a liquid crystal display device. As shown in FIG. 15, the manufacturing blocks of the liquid crystal device include sequentially performing a pattern forming block (block S50), a color filter forming block (block S52), a cell assembly block (block S54), and a module assembly block (block S56). The pattern forming block of block S50 is to form predetermined patterns such as a circuit pattern and an electrode pattern on a glass substrate coated with a photoresist, as a plate P, using the projection exposure apparatus of the above embodiment. This pattern forming block includes an exposure block, a development block, and a processing block. The exposure block is to transfer a pattern to a photoresist layer, using the projection exposure apparatus of the above embodiment. The development block is to perform development of the plate P to which the pattern is transferred, i.e., development of the photoresist layer on the glass substrate, to form the photoresist layer in the shape corresponding to the pattern. The processing block is to process the surface of the glass substrate through the developed photoresist layer.

The color filter forming block of block S52 is to form a color filter in which a large number of sets of three dots corresponding to R (Red), G (Green), and B (Blue) are arrayed in a matrix pattern, or in which a plurality of filter sets of three stripes of R, G, and B are arrayed in a horizontal scan direction. The cell assembly block of block S54 is to assemble a liquid crystal panel (liquid crystal cell), using the glass substrate on which the predetermined pattern has been formed in block S50, and the color filter formed in block S52. Specifically, for example, a liquid crystal is poured into between the glass substrate and the color filter to form the liquid crystal panel. The module assembly block of block S56 is to attach various components such as electric circuits and backlights for display operation of this liquid crystal panel, to the liquid crystal panel assembled in block S54.

The embodiment is not limited just to the application to the exposure apparatus for manufacture of semiconductor devices, but can also be widely applied, for example, to the exposure apparatus for display devices such as the liquid crystal display devices formed with rectangular glass plates, or plasma displays, and to the exposure apparatus for manufacture of various devices such as imaging devices (CCDs and others), micro machines, thin film magnetic heads, and DNA chips. Furthermore, the embodiment is also applicable to the exposure block (exposure apparatus) for manufacture of masks (photomasks, reticles, etc.) on which mask patterns of various devices are formed, by the photolithography process.

The above-described embodiment uses the ArF excimer laser light (wavelength: 193 nm) or the KrF excimer laser light (wavelength: 248 nm) as the exposure light, but, without having to be limited to this, it is also possible to apply any other appropriate laser light source, e.g., an F₂ laser light source which supplies laser light at the wavelength of 157 nm.

In the foregoing embodiment, it is also possible to apply a technique of filling the space in the optical path between the projection optical system and the photosensitive substrate with a medium having the refractive index larger than 1.1 (typically, a liquid), which is so called a liquid immersion method. In this case, it is possible to adopt one of the following techniques as a technique of filling the space in the optical path between the projection optical system and the photosensitive substrate with the liquid: the technique of locally filling the space in the optical path with the liquid as disclosed in International Publication No. WO99/49504; the technique of moving a stage holding the substrate to be exposed, in a liquid bath as disclosed in Japanese Patent Application Laid-Open No. 6-124873; the technique of forming a liquid bath of a predetermined depth on a stage and holding the substrate therein as disclosed in Japanese Patent Application Laid-open No. 10-303114, and so on. The teachings of International Publication No. WO99/49504, Japanese Patent Application Laid-Open No. 6-124873, and Japanese Patent Application Laid-open No. 10-303114 are incorporated herein by reference.

The foregoing embodiment was the illumination optical system for illuminating the mask (or the wafer) in the exposure apparatus, but, without having to be limited to this, it may be one of commonly-used illumination optical systems for illuminating an illumination target surface except for the mask (or the wafer).

The polarization converting unit according to the embodiment forms the light intensity distribution in the circumferentially polarized state with high continuity by cooperative action of the plurality of optically rotatory members having the same configuration. The optically rotatory members each have the plurality of divided regions resulting from the division along the circumferential direction around the optical axis on the plane perpendicular to the optical axis and are arranged along the optical-axis direction so that the partition lines between the corresponding divided regions are superimposed when viewed from the traveling direction of light. As a consequence, the maximum processing depth necessary for forming the required uneven shape of the optically rotatory members is kept relatively small. Furthermore, this configuration facilitates the manufacture of each optically rotatory member as a single member (single member having continuous surfaces) integrally formed by etching at least one surface of a plane-parallel plate of quartz crystal.

Namely, the polarization converting unit according to the embodiment has the configuration relatively easy to manufacture and is able to achieve the pupil intensity distribution in the circumferentially polarized state with high continuity when arranged in the optical path of the illumination optical system. The illumination optical system according to the embodiment is able to illuminate the illumination target surface with light in a desired circumferentially polarized state, using the polarization converting unit achieving the pupil intensity distribution in the circumferentially polarized state with high continuity. The exposure apparatus according to the embodiment is able to accurately transfer the microscopic pattern under an appropriate illumination condition to the photosensitive substrate, using the illumination optical system for illuminating the pattern surface as the illumination target surface with the light in the desired circumferentially polarized state, and, in turn, to manufacture excellent devices.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. A polarization converting unit arranged on an optical axis of an optical system and configured to convert a polarization state of propagating light passing along an optical-axis direction corresponding to the optical axis, the polarization converting unit comprising:
a first optically rotatory member to rotate linearly polarized light incident thereto as the propagating light, around the optical-axis direction, the first optically rotatory member being comprised of an optical material with an optical activity, which is arranged so as to have a crystal axis coincident or parallel with the optical-axis direction, and having a first thickness distribution of thicknesses in the optical-axis direction different at a plurality of locations; and
a second optically rotatory member to rotate linearly polarized light incident as the propagating light thereto through the first optically rotatory member, around the optical-axis direction, the second optically rotatory member being comprised of an optical material with an optical activity, which is arranged so as to have a crystal axis coincident or parallel with the optical-axis direction, and having a second thickness distribution of thicknesses in the optical-axis direction different at a plurality of locations,
wherein the first and second optically rotatory members are arranged so that the sum of respective thicknesses in the optical-axis direction at predetermined locations in the first and second optically rotatory members through which a first reference axis parallel to the optical-axis direction passes is different from the sum of respective thicknesses in the optical-axis direction at other locations in the first and second optically rotatory members through which a second reference axis parallel to the optical-axis direction and different from the first reference axis passes.

2. A polarization converting unit according to claim 1, wherein at least one of the first and second optically rotatory members is composed of a single member having a continuous surface.

3. A polarization converting unit according to claim 1, wherein at least one of the first and second optically rotatory members is composed of a single first divided member having a continuous surface and a single second divided member having a continuous surface.

4. A polarization converting unit according to claim 1, wherein at least one of the first and second optically rotatory members has a surface processed by etching at least one surface of a plane-parallel plate.

5. A polarization converting unit according to claim 1, wherein the first and second optically rotatory members are arranged so as to intersect with the optical axis, and
wherein at least one of the first and second optically rotatory members has a thickness in the optical-axis direction varying along a circumferential direction corresponding to a direction of rotation around the optical axis on a plane perpendicular to the optical axis,

6. A polarization converting unit according to claim 1, wherein the first and second optically rotatory members are arranged so as to intersect with the optical axis, and
wherein at least one of the first and second optically rotatory members is composed of a plurality of regions divided in a circumferential direction corresponding to a direction of rotation around the optical axis on a plane perpendicular to the optical axis, the plurality of regions being arranged so that two regions having respective thicknesses different in the optical-axis direction are adjacent to each other.

7. A polarization converting unit according to claim 6, wherein thicknesses of any two regions opposed to each other with the optical axis in between out of the plurality of regions are equal.

8. A polarization converting unit according to claim 6, wherein each of the plurality of regions has a contour obtained by dividing the optical material of a circular or annular shape along the circumferential direction of the optical material.

9. A polarization converting unit according to claim 1, wherein the first and second optically rotatory members are arranged so as to intersect with the optical axis, and
wherein at least one of the first and second optically rotatory members has a thickness distribution continuously varying along a circumferential direction corresponding to a direction of rotation around the optical axis on a plane perpendicular to the optical axis.

10. A polarization converting unit according to claim 1, wherein the first and second optically rotatory members have the same structure.

11. A polarization converting unit according to claim 10, wherein, when the first and second optically rotatory members are viewed along the optical-axis direction, the first and second optically rotatory members are arranged so that the first thickness distribution is coincident with the second thickness distribution.

12. A polarization converting unit according to claim 11, wherein each of the first and second optically rotatory members has a plurality of regions divided in a circumferential direction around the optical axis on a plane perpendicular to the optical axis, and
wherein, when the first and second optically rotatory members are viewed along the optical-axis direction, a region of the first optically rotatory member and a corresponding region of the second optically rotatory member superimposed on each other have the same thickness in the optical-axis direction.

13. A polarization converting unit according to claim 1, wherein each of the first and second optically rotatory members has a plurality of regions divided in a circumferential direction around the optical axis on a plane perpendicular to the optical axis, and
wherein, when the first and second optically rotatory members are viewed along the optical-axis direction, partition lines between the plurality of regions in the first optically rotatory member are superimposed on partition lines between the plurality of regions in the second optically rotatory member.

14. A polarization converting unit according to claim 1, wherein at least one of the first and second optically rotatory members is comprised of quartz crystal.

15. A polarization converting unit according to claim 1, wherein the first and second optically rotatory members are arranged in a state in which they are adjacent to each other along the optical-axis direction.

16. A polarization converting unit according to claim 1, wherein the polarization converting unit is arranged in an optical path of an illumination optical system configured to illuminate an illumination target surface with light from a light source, and in a pupil space including an illumination pupil of the illumination optical system.

17. A polarization converting unit according to claim 1, wherein each of the first and second thickness distributions is a distribution in which, along with position information of portions in the optical material, thicknesses in the optical-axis direction of the respective portions are made correspondent on a plane perpendicular to the optical-axis direction, and nonuniform distribution.

18. An illumination optical system configured to illuminate an illumination target surface with light from a light source and comprising a polarization converting unit according to claim 1, which is arranged in an optical path between the light source and the illumination target surface.

19. An illumination optical system according to claim 18, wherein the polarization converting unit is arranged in a pupil space including an illumination pupil of the illumination optical system.

20. An illumination optical system according to claim 19, wherein the illumination optical system is used in combination with a projection optical system configured to form a plane optically conjugate with the illumination target surface, and wherein the illumination pupil is arranged at a position optically conjugate with an aperture stop of the projection optical system.

21. An exposure apparatus configured to expose a photosensitive substrate to transfer a predetermined pattern thereto, the exposure apparatus comprising an illumination optical system according to according to claim 18 configured to illuminate the predetermined pattern.

22. An exposure apparatus according to claim 21, further comprising a projection optical system configured to form an image of the predetermined pattern on the photosensitive substrate.

23. A device manufacturing method, comprising:
exposing the photosensitive substrate to transfer the predetermined pattern thereto, using an exposure apparatus according to claim 21;
developing the photosensitive substrate to which the predetermined pattern is transferred, thereby to form a mask layer in a shape corresponding to the predetermined pattern on a surface of the photosensitive substrate; and
processing the surface of the photosensitive substrate through the mask layer.
